(19) United States
(12) Patent Application Publication
(10) Pub. No.: US 2019/0152806 A1
(43) Pub. Date: May 23, 2019

(54) HYBRID WATER FILTER

(71) Applicant: Honeywell International Inc., Morris Plains, NJ (US)

(72) Inventors: Marilyn Wang, Pudong New Area, Shanghai (CN); Kai Huang, Shanghai (CN); Xingping Wang, Shanghai (CN)

(21) Appl. No.: 16/098,034

(22) PCT Filed: May 3, 2016
(86) PCT No.: PCT/CN2016/080865

§ 371 Date: Oct. 31, 2018

(51) Int. Cl. C02F 1/28

(52) U.S. Cl. CPC C02F 1/288; C02F 2101/20; C02F 1/285; C02F 1/283

(57) ABSTRACT

A hybrid water filter is provided which includes a polypropylene stage and an activated carbon stage. Various embodiments provide a hybrid water filter including activated carbon fiber in contact with a polyolefin fiber having one or more chelating groups grafted thereon, and activated carbon powder, compact activated carbon, or a combination thereof. Various embodiments provide a device for filtering water including the hybrid water filter, a method of using the hybrid water filter, and a method of forming the hybrid water filter.

### BACKGROUND

Point-of-use water purification can be used for deep removal of trace contaminants. Purification can include several filtration stages using different technologies and materials, such as pre-filtration, reverse osmosis, microfiltration, ultrafiltration, nanofiltration, and materials such as FeO and Al₂O₃ for removal of heavy metal ions. However, use of multiple filter cartridges can add bulk to a filtration system, which is less convenient for the user. Some filter cartridges can suffer from incomplete coverage of water on the cartridge, such that only a portion of the cartridge is utilized during use.

### SUMMARY

A hybrid water filter includes a polypropylene stage and an activated carbon stage.

A hybrid water filter includes an outer hollow cylinder including a spunbond polypropylene stage. The hybrid water filter also includes an inner hollow cylinder including an activated carbon block stage, wherein the inside of the outer hollow cylinder is in contact with the outside of the inner hollow cylinder.

A device for filtering water includes a hybrid water filter including a polypropylene stage and an activated carbon stage. The device includes a housing configured to accept the water filter therein.

A method of using a hybrid water filter including a polypropylene stage and an activated carbon stage includes passing water through the hybrid water filter radically, to provide filtered water.

A method of forming a hybrid water filter including a polypropylene stage and an activated carbon stage includes heat welding polypropylene on an outside surface of a hollow cylinder including activated carbon.

A hybrid water filter includes activated carbon fiber and polyolefin fiber having one or more chelating groups grafted thereof. The activated carbon fiber and the polyolefin fiber are in contact with one another. The hybrid water filter also includes activated carbon powder, compact activated carbon, or a combination thereof.

A device for filtering water includes a hybrid water filter including activated carbon fiber and polyolefin fiber having one or more chelating groups grafted thereof, the water filter also including activated carbon powder, compact activated carbon, or a combination thereof. The device also includes a housing configured to accept the hybrid water filter therein.

A method of using a hybrid water filter including activated carbon fiber and polyolefin fiber having one or more chelating groups grafted thereof, the water filter also including activated carbon powder, compact activated carbon, or a combination thereof, includes passing through the hybrid water filter radially, to provide filtered water.

A method of making a hybrid water filter including activated carbon fiber and polyolefin fiber having one or more chelating groups grafted thereof, the water filter also including activated carbon powder, compact activated carbon, or a combination thereof, includes combining together an activated carbon fiber and a polyolefin fiber having one or more chelating groups grafted thereon to form a mat. The method includes applying activated carbon powder to the mat. The method includes forming the mat into a hollow cylinder, to form the hybrid water filter.

A method of making a hybrid water filter includes combining together an activated carbon fiber and a polyolefin fiber having one or more chelating groups grafted thereon to form a mat. The method includes forming the mat into a hollow cylinder including compact activated carbon within the center of the hollow cylinder.

In various embodiments, the present invention provides advantages over other water filters, at least some of which are unexpected. In various embodiments, the water filter of the present invention can use less space than other water filtration systems including both an activated carbon filter and a pre-filter. The majority of the volume of most polypropylene filters is wasted, with only the outer section of the filter being utilized for filtration, and with the inner sections of the filter remaining substantially contaminant-free. In various embodiments, the water filter of the present invention incorporates polypropylene in a more efficient manner such that a greater proportion of the volume of polypropylene is utilized for filtration. In various embodiments, the water filter of the present invention includes spunbond polypropylene, giving a lower pressure drop across the filter, an increased flow rate through the filter, increased capacity, or a combination thereof, as compared to other water filters, such as compared to water filters including meltblown polypropylene. In various embodiments, the water filter of the present invention including polypropylene and activated carbon provides a greater service life than other water filters. In various embodiments, the water filter of the present invention provides little to no channeling or bypassing during water filtration due to uniform construction of the filter.

In various embodiments, the hybrid water filter of the present invention can be more efficient than other water filters, such as by utilizing a greater proportion of the filter during use than other filters. In various embodiments, the hybrid water filter can provide about 100% or nearly 100% coverage of water on the filter during water filtration (e.g., 100% or nearly 100% of the filter can be used during the filtration). In various embodiments, the hybrid water filter can provide greater coverage of water on the filter during water filtration (e.g., use of a greater amount of the water filter) under a wider variety of inlet water pressures as compared to other water filters.

### BRIEF DESCRIPTION OF THE FIGURES

The drawings illustrate generally, by way of example, but not by way of limitation, various embodiments discussed in the present document.

FIG. 1 illustrates a cutaway side profile of an activated carbon polypropylene hybrid filter, in accordance with various embodiments.

FIG. 2 illustrates a water filter, in accordance with various embodiments.

FIG. 3 illustrates a photograph of water filtration media during testing, according to various embodiments.

FIG. 4 is a graph illustrating the removal rate of Pb and Cd versus the uptake for various filtration media, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

### Hybrid Water Filter Including Polypropylene.

In various embodiments, the present invention provides a hybrid water filter. The hybrid water filter can include a polypropylene stage and an activated carbon stage. The hybrid water filter can be a single water filter, such as a monolithic filter, configured to fit into a water filter housing wherein it can be used to filter water that flows into the housing.

The activated carbon stage can be any suitable filtration stage of the water filter (e.g., a part of the water filter wherein water to be filtered passes therethrough) that includes activated carbon. The water filter can be substantially free of water bypasses around the activated carbon stage. The activated carbon stage can be an activated carbon block. The activated carbon stage can include any suitable weight percent of activated carbon, such as about 10 wt % to about 100 wt %, about 80 wt % to about 100 wt %, 10 wt % or less, or less than, equal to, or greater than about 15 wt %, 20, 25, 30, 35, 40, 45, 50, 55, 60, 65, 70, 75, 80, 85, 90, 95, 96, 97, 98, 99, 99.9, 99.99, or about 99.999 wt % or more.

The polypropylene stage can be any suitable filtration stage of the water filter that includes polypropylene. The water filter can be substantially free of water bypasses around the polypropylene stage. The polypropylene stage can be polypropylene fibers, such as any suitable polypropylene fibers, such as spunbond polypropylene, meltblown polypropylene, or a combination thereof. Spunbond polypropylene can be produced by allowing extruded strands to at least partially solidify and then blowing them with air near room temperature sufficient to provide increased polymer orientation. Meltblown polypropylene can be produced by blowing extruded strands with hot air near the melt temperature of the extruded strands, causing them to form a fine fibrous and self-bonding web of fibers, providing more microfiber formation than spunbond but does not increase orientation of polymer strands as much as spunbond. The polypropylene can include chelating groups that have been grafted thereon, or the polypropylene can be substantially free of chelating groups. The polypropylene stage can include any suitable weight percent of activated carbon, such as about 10 wt % to about 100 wt %, about 80 wt % to about 100 wt %, or less than, equal to, or greater than about 15 wt %, 20, 25, 30, 35, 40, 45, 50, 55, 60, 65, 70, 75, 80, 85, 90, 95, 96, 97, 98, 99, 99.9, 99.99, or about 99.999 wt % or more.

The hybrid water filter can have any suitable shape, such that it can be used as described herein. The hybrid water filter can be a sheet. The hybrid water filter can be substantially shaped as a hollow cylinder, wherein the stages of the water filter form the walls of the hollow cylinder. The water filter can include an outer hollow cylinder including the polypropylene stage and an inner hollow cylinder including the activated carbon stage. In some embodiments, the inner hollow cylinder including the activated carbon stage can further include a plastic cover, such as a porous plastic cover, such as a plastic netting (e.g., polyethylene or polypropylene); in some embodiments, the polypropylene stage can be fused or welded to the plastic cover of the inner hollow cylinder including the activated carbon stage. In some embodiments, the inside of the outer hollow cylinder is in contact with the outside of the inner hollow cylinder. In some embodiments, the inside of the outer hollow cylinder is in contact with one or more other stages of the filter, which are in turn in contact with the outside of the inner hollow cylinder. In some embodiments, the inside of the inner hollow cylinder (e.g., including the activated carbon stage) is free of additional filtration stages, while in other embodiments, one or more additional filtration stages can be in contact with the inside of the inner hollow cylinder. In some embodiments, the outside of the outer hollow cylinder (e.g., including the polypropylene stage) can be free of additional filtration stages, while in other embodiments, one or more additional filtration stages can be in contact with the outside of the outer hollow cylinder.

In some embodiments, the hollow cylinder can include a carbon filter on the inside of the hollow cylinder. The carbon filter can be any suitable filter including activated carbon. The carbon filter can be a carbon stick.

In some embodiments, the polypropylene stage can further include activated carbon powder, such as added to the polypropylene as a powder or as a slurry. The activated carbon powder in the polypropylene stage can be any suitable proportion of the polypropylene stage, such as about 0.001 wt % to about 90 wt %, or about 1 wt % to about 30 wt %, or about 0.001 wt % or less, or less than, equal to, or more than about 0.01 wt %, 0.1, 1, 2, 3, 4, 5, 10, 15, 20, 25, 30, 35, 40, 45, 50, 55, 60, 65, 70, 75, 80, 85, or about 90 wt % or more.

The hollow cylinder filter can include one or more end caps, for example, caps on the top and bottom of the hollow cylinder. The caps can be closed (e.g., allow no water to pass therethrough) or open (e.g., including one or more orifices for the passage of water. The caps can substantially prevent flow of water out the ends of the walls of the hollow cylinder filter, forcing a flow of water to occur radially through the filter without bypassing or prematurely exiting any stage of the filter. For example, the end caps can substantially direct a flow of water through the outside of the hollow cylinder and emerging in the middle of the hollow cylinder. At least one of the end caps on a hollow cylinder including two end caps can including one or more orifices for the passage of water; in some embodiments, neither end cap is closed.

### Hybrid Water Filter Including Polyolefin Having One or More Chelating Groups Grafted Thereon.

In various embodiments, the present invention provides a hybrid water filter that includes an activated carbon fiber and that also includes a polyolefin fiber having one or more chelating groups grafted thereon, wherein the activated carbon fiber and the polyolefin fiber are in contact with one another. The contact can be any suitable contact; for example, the activated carbon fiber and the polyolefin fiber can be woven together or spun together. The hybrid water filter can include activated carbon powder, compact activated carbon, or a combination thereof. The hybrid water filter can be a single water filter, such as a monolithic filter, configured to fit into a water filter housing wherein it can be used to filter water that flows into the housing.

The weight ratio of the activated carbon fiber and the polyolefin fiber can be any suitable weight ratio, so long as the water filter can be used as described herein. For example, the weight ratio of the activated carbon fiber to the polyolefin fiber can be about 1:99 to about 99:1, or about 1:99 or less, or less than, equal to, or greater than about 10:90, 20:80, 30:70, 40:60, 50:50, 60:40, 70:30, 80:20, 90:10, or about 99:1 or more.

The polyolefin fiber can be any suitable polyolefin (e.g., a polymer formed from an olefin-containing compound), such as polyacrylate, polymethacrylate, polyacrylonitrile, poly(vinyl alcohol), polyethylene, polypropylene, or a combination thereof (e.g., a copolymer including two or more of the forgoing or multiple fibers made of different materials can be included). The grafted chelating groups on the polyolefin can chelate with and thereby remove or decrease the concentration of one or more heavy metal ions from the water being filtered, such as copper ions, zinc ions, cadmium ions, mercury ions, lead ions, silver ions, gold ions, arsenic ions, iron ions, nickel ions, or a combination thereof.

The hybrid water filter can be in the shape of a sheet. The hybrid water filter can be substantially in the shape of a hollow cylinder, and can optionally include one or more end caps to direct water flow radially with respect to the hollow cylinder.

In some embodiments, the hollow cylinder includes a compact activated carbon (e.g., a carbon stick) within the inside of the hollow cylinder. In some embodiments, the hollow cylinder can include activated carbon powder on the contacted activated carbon fiber and polyolefin fiber. The compact activated carbon, the activated carbon powder, or the combination thereof, can form any suitable proportion of the hybrid water filter, such as about 0.001 wt % to about 90 wt %, or about 5 wt % to about 50 wt %, about 10 wt % to about 40 wt %, or about 0.001 wt % or less, or less than, equal to, or more than about 0.01 wt %, 0.1, 1, 2, 3, 4, 5, 10, 15, 20, 25, 30, 35, 40, 45, 50, 55, 60, 65, 70, 75, 80, 85, or about 90 wt % or more.

A polyolefin fiber can having chelating groups grafted thereon in any suitable way. The polyolefin fiber can be treated with an amine compound to form a chelating fiber. The polyolefin fiber can be first treated with another material prior to treatment with the amine, such as a vinyl epoxide, such as glycidyl methacrylate. A vinyl epoxide can be grafted to the polyolefin via any suitable method, such as via irradiation. An amine can subsequently react with the epoxide to form the chelating group. The amine compound can be any suitable amine compound, such as hydrazine, hydroxylamine hydrochloride, ethanolamine, ethylene diamine, tetramethylene diamine and/or diethylene triamine.

In some embodiments, the modification of the polyolefin to form grafted chelating groups thereon can include the reaction of nitrile groups with the amine to form an amide with a chelating group attached thereto, as shown in Scheme 1.

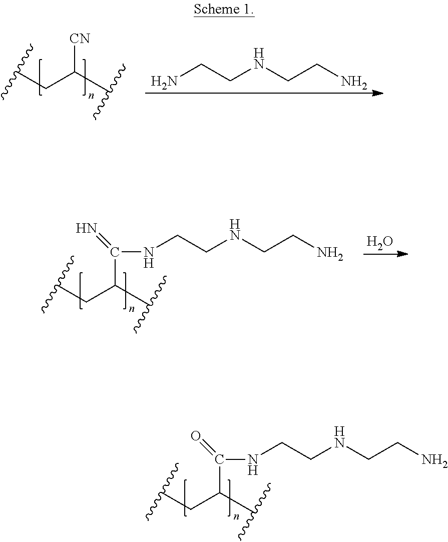

Scheme 2 illustrates a reaction of a secondary amine with nitrile group on the polyolefin to form a grafted chelating group thereon.

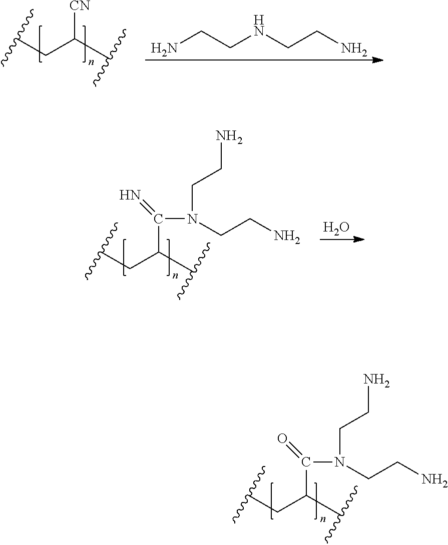

The chelating groups can be any suitable chelating groups. The chelating groups can be an amide, an amine, an amidoxide, a thiourea, or any combination thereof

### Device for Filtering Water.

In various embodiments, the present invention provides a device for filtering water. The device can be any suitable device that includes an embodiment of the hybrid water filter described herein, wherein the device can be used to filter water through the hybrid water filter. In some embodiments, the device can include the hybrid water filter and a housing configured to accept the water filter therein. The housing can include one or more water inlets, and one or more water outlets. The housing can be configured such that water that is flowed through the one or more inlets is directed through the hybrid water filter, such as in a radial direction from the outside of a hollow cylinder hybrid water filter to the inside of the hollow cylinder, to provide filtered water that is flowed out of the one or more outlets.

### Method of Using the Hybrid Water Filter.

In various embodiments, the present invention provides a method of using a hybrid water filter. The method can be any suitable method that includes using an embodiment of the hybrid water filter described herein for water filtration. The method can include passing water through the hybrid filter, to provide filtered water. The water can be passed through the hybrid filter in any suitable way, which can depend on the shape of the filter. For a hybrid filter that is a hollow cylinder, the method can include passing water through the hybrid filter radially, such as from the outside of the hollow cylinder to the inside of the hollow cylinder, to provide filtered water.

### Method of Making Hybrid Water Filter Including Polypropylene.

In various embodiments, the present invention provides a method of making a hybrid water filter including polypropylene. The method can be any suitable method that can form an embodiment of the hybrid water filter including polypropylene described herein. For example, the method can include heat welding polypropylene on an outside surface of a hollow cylinder including an activated carbon stage. The heat welding can be performed in any suitable way, such as by ultrasonic melting (e.g., ultrasonic welding, using absorption of ultrasonic vibration energy to induce local melting of the materials to be welded together).

### Method of Making Hybrid Water Filter Including Polyolefin Having One or More Chelating Groups Grafted Thereon.

In various embodiments, the present invention provides a method of making a hybrid water filter including polyolefin having one of more chelating groups grafted thereon. The method can be any suitable method that can form an embodiment of the hybrid water filter including a polyolefin having one or more chelating groups grafted thereon described herein.

For example, the method can include combining together an activated carbon fiber and a polyolefin fiber having one of more chelating groups grafted thereon to form a mat. The method can include applying activated carbon powder to the mat. The method can include forming the mat into a hollow cylinder (e.g., rolling), to form the hybrid water filter.

Combining the activated carbon fiber and the polyolefin fibers can be performed in any suitable way, such as by weaving or spinning the fibers together. The activated carbon powder can be applied to the mat in any suitable way, such as by applying the powder directly thereto, or such as by applying a slurry including the powder to the mat (e.g., applying an aqueous- or organic solvent-slurry of the carbon powder to the mat and optionally allowing the water or organic solvent to substantially evaporate or dry), or a combination thereof.

The method can include combining together an activated carbon fiber and a polyolefin fiber having one of more chelating groups grafted thereon to form a mat. The method can include forming the mat into a hollow cylinder including compact activated carbon within the center of the hollow cylinder.

### EXAMPLES

Various embodiments of the present invention can be better understood by reference to the following Examples which are offered by way of illustration. The present invention is not limited to the Examples given herein.

### Part I. Polypropylene/Activated Carbon Hybrid Filter.

### Example 1-1. Hybrid Filter

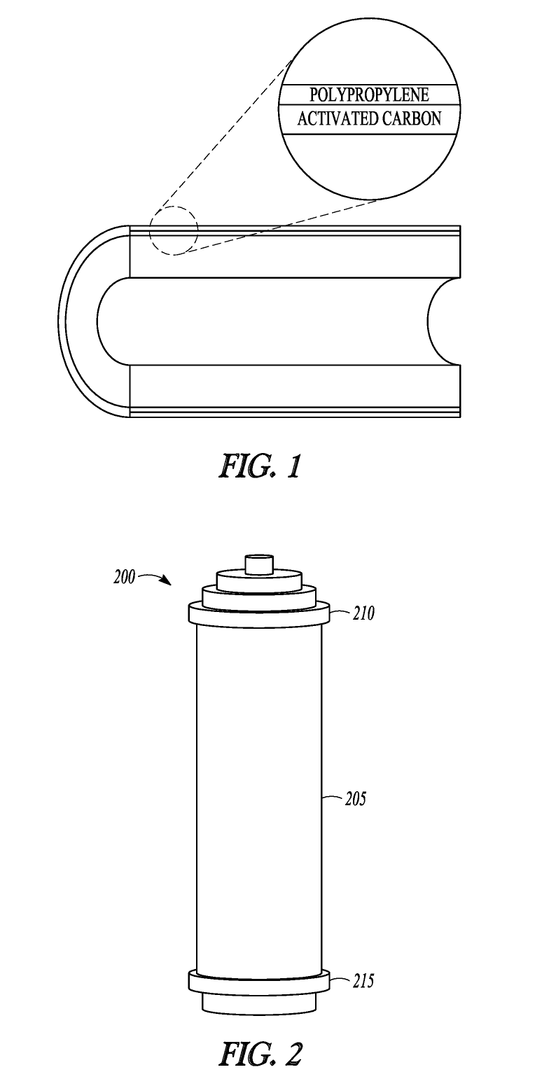

A 10-inch (25.4 cm) length hollow cylinder carbon block (activated carbon) filter was obtained, having an outer diameter of about 60-65 mm, an inner diameter of about 30 mm, and having a thickness of about 30-35 mm. The outside of the carbon block filter included a plastic cover (polypropylene netting). A sheet of spunbond polypropylene was prepared having a 10-inch (25.4 cm) width and a length about equal to the circumference of the carbon block filter. The spunbond polypropylene was heat welded to the outer plastic cover of the carbon block filter using ultrasonic melting. The filter was sealed with hotmelt adhesive and end caps were added to the top and bottom ends, to form the completed hybrid filter. A cutaway side profile of the filter is shown in FIG. 1. The completed filter 200 is illustrated in FIG. 2, with the hollow cylinder 205 and the end caps 210 and 215.

### Example 1-2. Meltblown Versus Spunbond Polypropylene Performance

A meltblown polypropylene and a spunbond polypropylene were tested for water filtration performance, using a testing area of 100 cm², a testing flow rate of 55 L/min, using TSI 8130 testing equipment, and using a sample having a thickness of 5 mm. The water used during the testing has a pollutant particle size of 0.3 microns. The results of the testing are shown in Table 1. The data shows lower pressure drops and better dust holding capacity of spunbond polypropylene as compared to meltblown polypropylene while retaining similar filtration efficiency.

TABLE 1
Meltblown versus spunbond polypropylene.

| | | |
|---|---|---|
| Property (Testing Area: 100 cm²) | Unit | Typical average |

Meltblown PP Matrerial

| | | |
|---|---|---|
| Pressure drop @55 L/min | Pa | 58 |
| Filtration efficiency @55 L/min | % | 93.2 |
| Dust-holding Capacity | gram | 0.7 |

Spunbond PP Material

| | | |
|---|---|---|
| Pressure drop @55 L/min | Pa | 9 |
| Filtration efficiency @55 L/min | % | 93.1 |
| Dust-holding Capacity | gram | 6 |

Part II. Hybrid Water Filter Media with Improved Efficiency.

### Example 2-1. Hybrid Water Filter Media (Comparative)

Chelating fibers were formed by grafting glycidyl methacrylate onto polypropylene fibers, and subsequently treating the fibers with diethylenetriamine. Active carbon fibers were spun with chelating fibers to form a sheet shape, using about 1:1 by weight of activated carbon fibers and polypropylene fibers. The sheet was rolled into a hollow cylinder, which was sealed and end caps were added to form a filter cartridge.

### Example 2-2. Hybrid Water Filter Media

A filter cartridge was formed as described in Example 2-1, but before rolling the sheet into a hollow cylinder, 30×60 mesh carbon powder was sprinkled on the sheet dispersedly, such that the filter was about 30 wt % carbon powder.

### Example 2-3. Filtration Performance

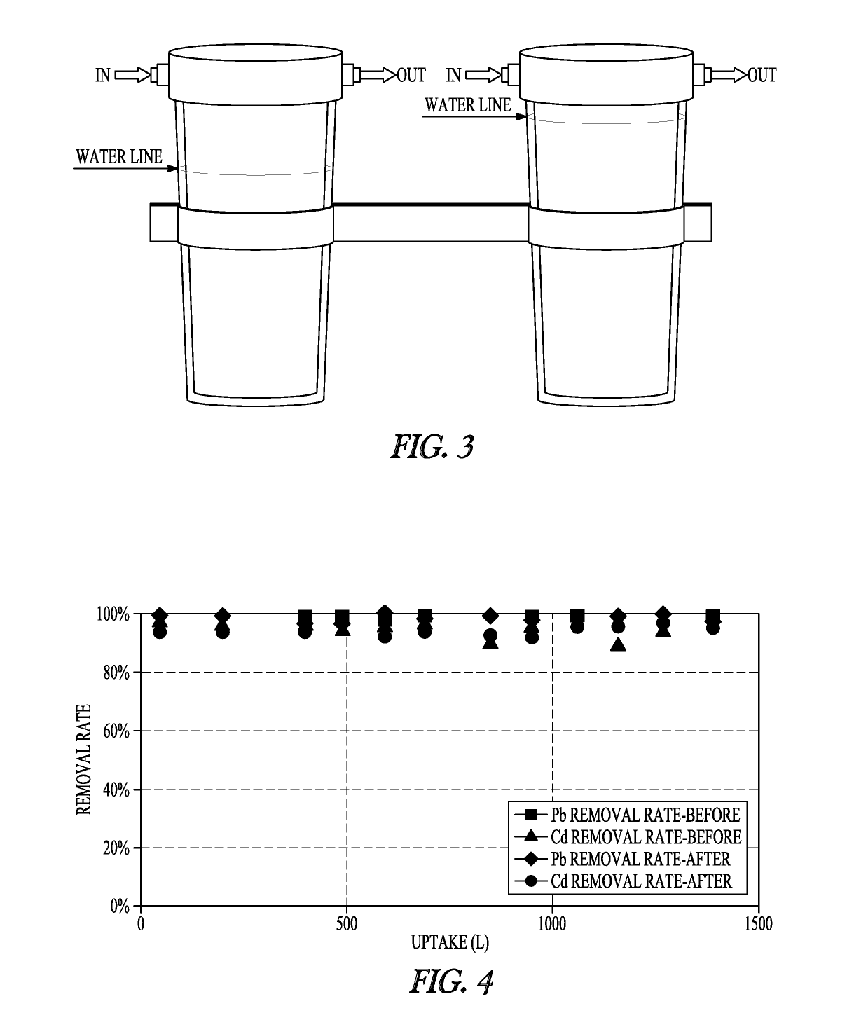

The filtration cartridges formed in Examples 2-1 and 2-2 were placed in housings and tested. FIG. 3 illustrates the filtration media during testing, which shows that the filtration media from Example 2-1 had decreased water coverage (on left side of FIG. 3, about 60% water coverage), while the filtration media from Example 2-2 had about 100% water coverage (on right side of FIG. 3).

Table 2 illustrates the lead (Pb) and cadmium (Cd) removal rate of the filtration media of Examples 2-1 and 2-2. The data illustrates little to no performance deterioration of the filtration media from Example 2-2 as compared to that from Example 2-1. FIG. 4 is a graph showing the removal rate of Pb and Cd versus the uptake for the filtration media of Examples 2-1 and 2-2.

TABLE 2
Pb and Cd removal rates of water filtration media
from Examples 2-1 and 2-2.

| | Example 2-1 | | Example 2-2 | |
|---|---|---|---|---|
| | Pb removal | Cd removal | Pb removal | Cd removal |
| Uptake (L) | rate | rate | rate | rate |
| 50 | 98.78% | 98.05% | 99.23% | 94.07% |
| 200 | 98.53% | 95.07% | 98.77% | 94.36% |
| 400 | 99.40% | 95.93% | 97.95% | 94.19% |
| 490 | 99.43% | 94.83% | 96.93% | 98.62% |
| 590 | 98.02% | 95.58% | 99.43% | 92.55% |
| 688 | 99.57% | 95.37% | 98.94% | 94.00% |
| 850 | 99.66% | 90.51% | 99.18% | 92.76% |
| 950 | 99.48% | 95.73% | 98.43% | 91.94% |
| 1060 | 99.15% | 96.38% | 97.55% | 95.68% |
| 1160 | 99.14% | 89.15% | 99.08% | 95.93% |
| 1270 | 99.14% | 94.52% | 99.69% | 96.89% |
| 1390 | 99.20% | 95.44% | 98.27% | 95.00% |

### Additional Embodiments

The following exemplary embodiments are provided, the numbering of which is not to be construed as designating levels of importance:

Embodiment 1 provides a hybrid water filter comprising:

a polypropylene stage; and

an activated carbon stage.

Embodiment 2 provides the hybrid water filter of Embodiment 1, wherein the hybrid water filter is a single water filter cartridge.

Embodiment 3 provides the hybrid water filter of any one of Embodiments 1-2, wherein the activated carbon stage is an activated carbon block stage.

Embodiment 4 provides the hybrid water filter of any one of Embodiments 1-3, wherein the polypropylene stage comprises spunbond polypropylene, meltblown polypropylene, or a combination thereof.

Embodiment 5 provides the hybrid water filter of any one of Embodiments 1-4, wherein the polypropylene stage comprises polypropylene fibers comprising chelating groups thereon.

Embodiment 6 provides the hybrid water filter of any one of Embodiments 1-5, wherein the water filter is substantially shaped as a hollow cylinder.

Embodiment 7 provides the hybrid water filter of Embodiment 6, wherein the water filter comprises an outer hollow cylinder comprising the polypropylene stage and an inner hollow cylinder comprising the activated carbon stage.

Embodiment 8 provides the hybrid water filter of Embodiment 7, wherein the inside of the outer hollow cylinder is in contact with the outside of the inner hollow cylinder.

Embodiment 9 provides the hybrid water filter of any one of Embodiments 6-8, further comprising a carbon filter inside the hollow cylinder.

Embodiment 10 provides the hybrid water filter of Embodiment 9, wherein the carbon filter inside the hollow cylinder comprises a carbon stick filter.

Embodiment 11 provides the hybrid water filter of any one of Embodiments 1-10, wherein the polypropylene stage further comprises activated carbon powder.

Embodiment 12 provides the hybrid water filter of any one of Embodiments 1-11, further comprising one or more end caps.

Embodiment 13 provides a device for filtering water, the device comprising:

the hybrid water filter of any one of Embodiments 1-12; and

a housing configured to accept the water filter therein.

Embodiment 14 provides a method of using the hybrid water filter of any one of Embodiments 1-12, the method comprising passing water through the hybrid water filter radially, to provide filtered water.

Embodiment 15 provides a method of using the water filter of any one of Embodiments 6-12, the method comprising passing water through the hybrid water filter radially from the outside of the hollow cylinder to the inside of the hollow cylinder, to provide filtered water.

Embodiment 16 provides a method of forming the hybrid water filter of any one of Embodiments 1-12, comprising heat welding polypropylene on an outside surface of a hollow cylinder comprising the activated carbon stage.

Embodiment 17 provides the method of Embodiment 16, wherein the heat welding comprises ultrasonic melting.

Embodiment 18 provides a hybrid water filter comprising:

an outer hollow cylinder comprising a spunbond polypropylene stage; and

an inner hollow cylinder comprising an activated carbon block stage, wherein the inside of the outer hollow cylinder is in contact with the outside of the inner hollow cylinder.

Embodiment 19 provides a hybrid water filter comprising:

activated carbon fiber;

polyolefin fiber having one or more chelating groups grafted thereon, wherein the activated carbon fiber and the polyolefin fiber are in contact with one another; and

activated carbon powder, compact activated carbon, or a combination thereof.

Embodiment 20 provides the hybrid water filter of Embodiment 19, wherein the activated carbon fiber and the polyolefin fiber are woven or spun together.

Embodiment 21 provides the hybrid water filter of any one of Embodiments 19-20, wherein the polyolefin fiber comprises polyacrylate, polyacrylonitrile, polymethacrylate, poly(vinyl alcohol), polyethylene, polypropylene, or a combination thereof.

Embodiment 22 provides the hybrid water filter of any one of Embodiments 19-21, wherein the hybrid water filter is substantially in the shape of a hollow cylinder.

Embodiment 23 provides the hybrid water filter of any one of Embodiments 19-22, wherein the compact activated carbon is within the inside of the hollow cylinder.

Embodiment 24 provides the hybrid water filter of any one of Embodiments 19-23, wherein the activated carbon powder is on the contacted activated carbon fiber and polyolefin fiber.

Embodiment 25 provides a device for filtering water, the device comprising:

the hybrid water filter of any one of Embodiments 19-24; and

a housing configured to accept the water filter therein.

Embodiment 26 provides a method of using the hybrid water filter of any one of Embodiments 19-24, the method comprising:

passing through the hybrid water filter radially, to provide filtered water.

Embodiment 27 provides a method of making the hybrid water filter of any one of Embodiments 19-26, the method comprising:

combining together an activated carbon fiber and a polyolefin fiber having one or more chelating groups grafted thereon to form a mat;

applying activated carbon powder to the mat; and

forming the mat into a hollow cylinder, to form the hybrid water filter of any one of Embodiments 19-27.

Embodiment 28 provides the method of Embodiment 27, wherein the activated carbon powder is applied to the combined activated carbon fiber and the polyolefin fibers in the form of a slurry or a powder.

Embodiment 29 provides a method of making the hybrid water filter of any one of Embodiments 19-26, the method comprising:

combining together an activated carbon fiber and a polyolefin fiber having one or more chelating groups grafted thereon to form a mat; and

forming the mat into a hollow cylinder comprising compact activated carbon within the center of the hollow cylinder.

Embodiment 30 provides the hybrid water filter, device, or method of any one or any combination of Embodiments 1-29 optionally configured such that all elements or options recited are available to use or select from.

1-10. (canceled)

11. A hybrid water filter comprising:
a polypropylene stage; and
an activated carbon stage.

12. The hybrid water filter of claim 11, wherein the hybrid water filter is a single water filter cartridge.

13. The hybrid water filter of claim 11, wherein the polypropylene stage comprises spunbond polypropylene, meltblown polypropylene, or a combination thereof.

14. The hybrid water filter of claim 11, wherein the polypropylene stage comprises polypropylene fibers comprising chelating groups thereon.

15. The hybrid water filter of claim 11, wherein the water filter is substantially shaped as a hollow cylinder.

16. The hybrid water filter of claim 11, wherein the polypropylene stage further comprises activated carbon powder.

17. The hybrid water filter of claim 11, further comprising one or more end caps.

18. A device for filtering water, the device comprising:
the hybrid water filter of claim 11; and
a housing configured to accept the water filter therein.

19. A method of using the hybrid water filter of claim 11, the method comprising:
passing water through the hybrid water filter radially, to provide filtered water.

20. A method of using the water filter of claim 15, the method comprising:
passing water through the hybrid water filter radially from the outside of the hollow cylinder to the inside of the hollow cylinder, to provide filtered water.

21. A method of forming the hybrid water filter of claim 11, comprising:
heat welding polypropylene on an outside surface of a hollow cylinder comprising the activated carbon stage.

22. A hybrid water filter comprising:
an outer hollow cylinder comprising a spunbond polypropylene stage; and
an inner hollow cylinder comprising an activated carbon block stage, wherein the inside of the outer hollow cylinder is in contact with the outside of the inner hollow cylinder.

23. A hybrid water filter comprising:
activated carbon fiber;
polyolefin fiber having one or more chelating groups grafted thereon, wherein the activated carbon fiber and the polyolefin fiber are in contact with one another; and
activated carbon powder, compact activated carbon, or a combination thereof.

24. The hybrid water filter of claim 23, wherein the activated carbon fiber and the polyolefin fiber are woven or spun together.

25. The hybrid water filter of claim 23, wherein the hybrid water filter is substantially in the shape of a hollow cylinder, wherein the compact activated carbon is within the inside of the hollow cylinder.

26. The hybrid water filter of claim 23, wherein the activated carbon powder is on the contacted activated carbon fiber and polyolefin fiber.

27. A device for filtering water, the device comprising:
the hybrid water filter of claim 23; and
a housing configured to accept the water filter therein.

28. A method of using the hybrid water filter of claim 23, the method comprising:
passing through the hybrid water filter radially, to provide filtered water.

29. A method of making the hybrid water filter of claim 23, the method comprising:
combining together an activated carbon fiber and a polyolefin fiber having one or more chelating groups grafted thereon to form a mat;
applying activated carbon powder to the mat; and
forming the mat into a hollow cylinder, to form the hybrid water filter

30. A method of making the hybrid water filter of claim 23, the method comprising:
combining together an activated carbon fiber and a polyolefin fiber having one or more chelating groups grafted thereon to form a mat; and
forming the mat into a hollow cylinder comprising compact activated carbon within the center of the hollow cylinder, to form the hybrid water filter.
